(19) United States
(12) Patent Application Publication
(10) Pub. No.: US 2014/0143019 A1
(43) Pub. Date: May 22, 2014

(54) MANAGING MODELED AUDIENCE EXTENSION INFORMATION

(71) Applicant: EXELATE, New York, NY (US)

(72) Inventors: Kevin Lyons, New York, NY (US); Elad Efraim, New York, NY (US)

(73) Assignee: EXELATE, New York, NY (US)

(21) Appl. No.: 13/682,267

(22) Filed: Nov. 20, 2012

(51) Int. Cl. G06Q 30/02

(52) U.S. Cl. CPC G06Q 30/0204
USPC 705/7.33

(57) ABSTRACT

A method, system, and medium for managing modeled audience extension information that includes receiving tag information, the tag information comprising a user identifier corresponding to a user, a tag identifier, and one or more data values; adding the tag identifier and the one or more data values to a user object, wherein the user object is identified by the user identifier; assigning the user object to a segment based on the user object and a model, wherein the segment is identified by a segment identifier; and distributing the segment identifier and the user identifier to a market information buyer.

### FIELD

Various embodiments may be generally directed to managing modeled audience extension (maX) information. Some embodiments may be particularly directed to methods, systems, and media for managing maX information.

### BACKGROUND

Targeting and data collection techniques provide advertisers and other marketing organizations with market segment data related to advertising viewers, including, for example, computer users who view advertising on the World Wide Web (Web) or Internet. For advertising viewers such as Internet users, the available information related to each user depends, for example, on his or her historical Web behavior and, for example, on his or her origin environment, such as the user's computing platform, service provider, country, time of day, etc. A “market segment” or “segment” is a subset, or partial portion of a group that can be characterized in some way; a segment may also be a data object describing such a group.

Advertisers and other marketing organizations may create segment definitions to define groups of potential marketing targets (e.g., users) and direct advertising to those groups, such as groups of users on the Internet. “Data publishers” (or “data sellers”) may sell information concerning targets or people, such as Internet users, and their behaviors, which advertisers and other marketing organizations may use to create, for example, behavioral segment definitions. An Internet user may access a Web site of a data publisher, such as a bicycling interest Web site, for example, and be identified as a user “interested in bicycling.” Other attributes, such as time and location of the person's access, may also be identified. Data publishers may sell the identifying information about users who access their sites and receive income from sales based on this information's use.

User identification (ID) data from data publishers can be used to create segment definitions. In general, segment definitions may be characterized by specific values for available properties. For example, segment definitions might exist for categories such as “Gender”, “Age” and “Nationality” and one segment combination might be defined with three properties as, “Male, 35-40, European.” Once identified (e.g., from information from a data publisher (data seller)), a user who fits the characteristics of “Male, 35-40, European” can be grouped into and/or associated with this segment combination. An advertisement can be exposed to (or placed) with users identified with the segment combination, and data can be collected to determine how the users identified with that segment respond. Behavioral segment definitions for “Shopping Interest”, “Running Interest” and “Web surfing interest” can be defined and Behavioral attributes, such as “likes to shop”, “intensely likes running” or “Web surfs in the evening” can also be included in segment combinations. Segment combinations can have attributes that are purely behavioral, purely non-behavioral or a mixture of behavioral and non-behavioral.

The efficiency of a given advertisement depends on the match between the content of the advertisement (advertising content) and the market segment to which the content is exposed. In practice, a numeric “conversion ratio” value describes the efficiency or “success” relationship between the advertising content and target segment. A high conversion ratio value can show, for example, by various measures or various methods of determining or collecting such data, that a given advertisement or advertising campaign (group of advertisements) is well received by a given target segment.

It is perceived within the advertising and marketing industries that, in general, better and more accurate segment targeting capabilities could improve conversion ratios. High conversion ratios for advertisements, on the Internet and in other advertising venues, such as, e.g., print, outdoor, direct are desirable. Identification, for example, of a large user group with a high response rate to advertising and with members who respond in stable and predictable manners over time is desirable.

Within Internet marketing, serving systems for organizations executing advertisement placement in advertising campaigns may execute “media optimization” when placing an advertisement on a particular Web site or with a particular media publisher. Media optimization may include analyzing parameters in segment combinations to identify values for each parameter that may yield the “best results” for each advertisement the serving system runs. A serving system may be a networked computing system that enables an operator to place advertisements on particular Web pages. Serving systems place advertisements on behalf of an advertiser or advertising agency, and can be operated by a number of entities such as an independent operator working with an advertiser or advertising agency.

With the development of the Internet advertising market, information about the people most likely to visit a website and information about the people most likely to purchase a product from visiting a website is increasingly more valuable. These people may be classified into modeled audience extensions, which defines segments that define users most likely to take certain actions. More accurate and efficient identification of modeled audience extensions can lead to more conversions and better return on investment for advertising money spent.

Serving systems using available media optimization algorithms have distinct limitations. Automatic systems exist, but with such systems, segment content does not get improved with the time. Such systems, generally, use “raw” segment data as received from a data publisher (data seller). An algorithm for media optimization looking at such data can, for example, identify that a given creative works well (e.g. gets a high conversion ratio) when displayed to users on weekends. Based on that high weekend response, a media optimization using such live user data may show that the creative in question should be used mostly on weekends. This type of algorithm ignores past data, however, so, for example, the algorithm may not identify the fact that the campaign related to the creative works better for people who expressed an interest in technology gadgets within the last 30 days. Such an algorithm, for example, also does not allow for improvements as more data is amassed.

Another drawback in current systems is that such systems may not be able to place people into segments that define the most likely people to visit a website or most likely people to purchase a product from visiting a website without a tremendous amount of pre-processing. Such systems typically require processing large amounts of data slowly on back-end systems in order to classify people and cannot provide an immediate and accurate classification in a real-time speeds.

Another drawback in current systems is that such systems provide only limited centralization. A centralized system may, for example, allow handling of different data types, such as the different types of data provided by different types of data publishers (“data sellers”). Using behavioral aspects from a wide group of data publishers may provide an advantage in manipulating a wide variety of data and could enhance segment groupings. Such a centralized system, may also, when accessed by “market information buyers”, may further be able to improve the segment data over time and provide it in a manner that permits further automation of data buyer and data seller systems.

In general, there is a need for improved techniques for managing modeled audience extension information, in the advertising and marketing fields in general and, in particular, with regard to Internet advertising.

### SUMMARY

Various embodiments are generally directed to managing modeled audience extension information to overcome the aforementioned problems.

One embodiment includes a method for managing modeled audience extension information, the method comprising: receiving tag information, the tag information comprising a user identifier corresponding to a user, a tag identifier, and one or more data values; adding the tag identifier and the one or more data values to a user object, wherein the user object is identified by the user identifier; assigning, by a server, the user object to a segment based on the user object and a model, wherein the segment is identified by a segment identifier; and distributing the segment identifier and the user identifier to a market information buyer.

One embodiment includes a system for managing modeled audience extension information, the system comprising: a memory; and a processor configured to: receive tag information, the tag information comprising a user identifier corresponding to a user, a tag identifier, and one or more data values; add the tag identifier and the one or more data values to a user object, wherein the user object is identified by the user identifier; assign the user object to a segment based on the user object and a model, wherein the segment is identified by a segment identifier; and distribute the segment identifier and the user identifier to a market information buyer.

One embodiment includes a computer readable storage medium for managing modeled audience extension information, the computer readable storage medium comprising instructions that if executed enable a computing system to: receive tag information, the tag information comprising a user identifier corresponding to a user, a tag identifier, and one or more data values; add the tag identifier and the one or more data values to a user object, wherein the user object is identified by the user identifier; assign the user object to a segment based on the user object and a model, wherein the segment is identified by a segment identifier; and distribute the segment identifier and the user identifier to a market information buyer.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a schematic block diagram of an exemplary system in accordance with one or more embodiments.

FIG. 2 depicts a schematic data flow diagram of an exemplary system in accordance with one or more embodiments.

FIG. 3 depicts a block flow diagram of an exemplary method for managing modeled audience extension information in accordance with one or more embodiments.

FIG. 4 depicts an exemplary architecture for implementing a computing device in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

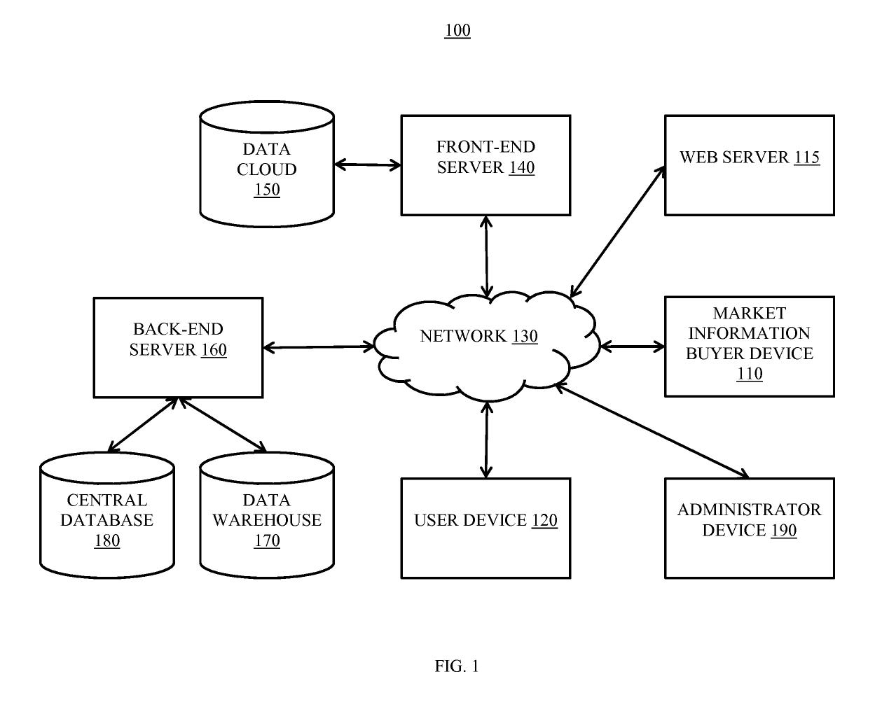

FIG. 1 depicts a schematic block diagram of an exemplary system in accordance with one or more embodiments. System 100 may include market information buyer device 110, web server 115, user device 120, network 130, front-end server 140, data cloud 150, back-end server 160, data warehouse 170, central database 180, and administrator device 190.

Market information buyer device 110, user device 120, and administrator device 190 may be any type of computing device, including a mobile telephone, a laptop, tablet, or desktop computer having, a netbook, a video game device, a pager, a smart phone, an ultra-mobile personal computer (UMPC), or a personal data assistant (PDA). Market information buyer device 110, user device 120, and administrator device 190 may run one or more applications, such as Internet browsers, voice calls, video games, videoconferencing, and email, among others. Market information buyer device 110, user device 120, and administrator device 190 may be any combination of computing devices. These devices may be coupled to network 130.

Web server 115, front-end server 140, or back-end server 160 may also be any type of computing device coupled to network 130, including but not limited to a personal computer, a server computer, a series of server computers, a mini computer, and a mainframe computer, or combinations thereof. Web server 115, front-end server 140, or back-end server 160 may be a web server (or a series of servers) running a network operating system, examples of which may include but are not limited to Microsoft Windows Server, Novell NetWare, or Linux.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a layer 3 virtual private network (VPN), an enterprise IP network, or any combination thereof.

Data cloud 150 may be any combination of hardware or software used to store information in a distributed and redundant manner. Data cloud 150 may be implemented in or managed by front-end server 140, other servers, or any combination thereof. Data cloud 150 may be distributed across a number of devices, in which each device may replicate all of the data or portions of the data stored on any combination of devices used by data cloud 150. Data cloud 150 may be configured to be updated in real-time when one or more of the devices housing data cloud 150 receives new data. For example, when information is added to or stored on data cloud 150 by front-end server 140, the information may be distributed to other servers maintaining data cloud 150 in real-time. Data cloud 150 may be configured to store any type or combination of data discussed herein. Data cloud 150 may be configured to only store data for a certain period of time. For example, data cloud 150 may expunge any data that has been in data cloud 150 for more than 60 days. The period of time may be any period of time.

Data warehouse 170 and central database 180 may be any type of database, including databases managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, and PostgreSQL. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

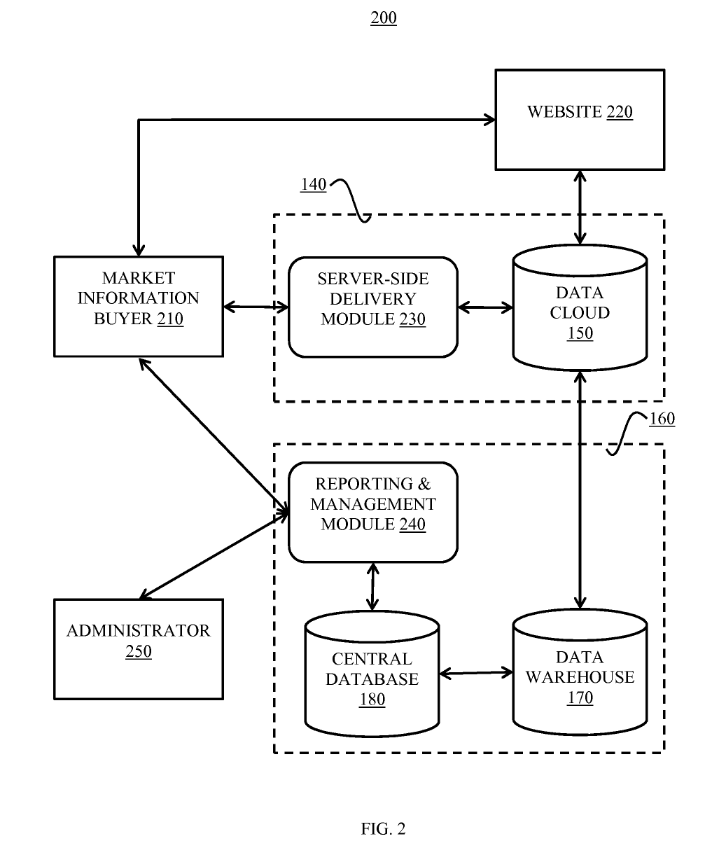

FIG. 2 depicts a schematic data flow diagram of an exemplary system in accordance with one or more embodiments. System 200 may include front-end server 140, data cloud 150, back-end server 160, data warehouse 170, central database 180, market information buyer 210, website 220, server-side delivery module 230, reporting and management module 240, and administrator device 250.

Market information buyer 210 may be an individual, group, organization, or any combination thereof. Administrator 250 may also be an individual, group, organization, or any combination thereof.

Website 220 may be any type of website or web page. For example, website 220 may be coded using hypertext markup language (“HTML”), XML, XHTML, JavaScript, Java, Perl, Visual Basic, Hypertext Preprocessor scripts (“PHP”), Active Server Page scripts (“ASP”), common gate interface (“CGI”) scripts, server side includes, and combinations thereof.

Server-side delivery module 230 may be a module that is configured to send and receive information at front-end server 140. Server-side delivery module 230 may provide another mechanism for sending and receiving data at front-end server 140 besides handling requests through web server 115. Server-side delivery module 230 may send and receive information using any technique for sending and receiving information between processes or devices including using a scripting language, a remote procedure call, an email, a tweet, an application programming interface, Simple Object Access Protocol (SOAP) methods, Common Object Request Broker Architecture (CORBA), any interface for software components to communicate with each other, using any other known technique for sending information from a one device to another, or any combination thereof.

Reporting and management module 240 may be a module that is configured to send and receive information at back-end server 160. Reporting and management module 240 may provide a mechanism for sending and receiving data at back-end server 160. Reporting and management module 240 may send and receive information using any technique for sending and receiving information between processes or devices including using a scripting language, a remote procedure call, an email, a tweet, an application programming interfaces, any interface for software components to communicate with each other, Simple Object Access Protocol (SOAP) methods, Common Object Request Broker Architecture (CORBA), using any other known technique for sending information from a one device to another, or any combination thereof.

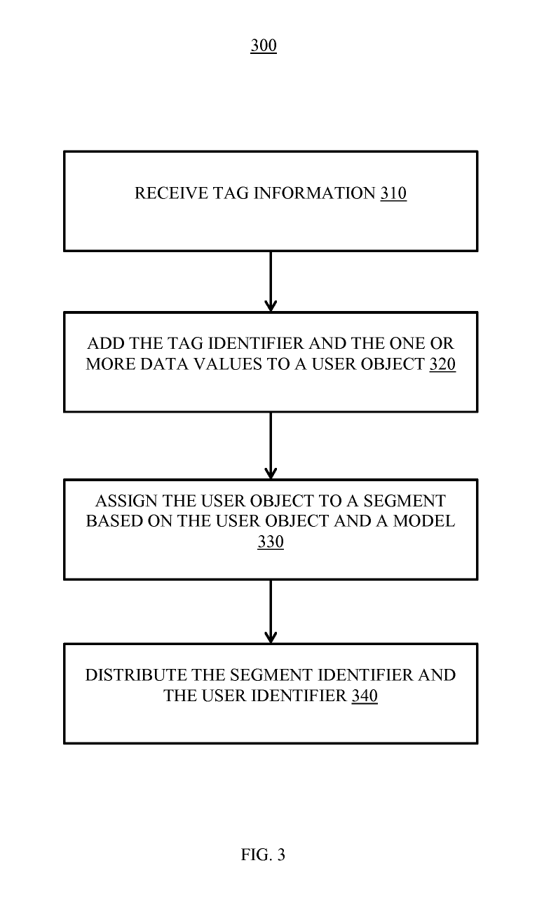

FIG. 3 depicts a block flow diagram of an exemplary method for managing modeled audience extension information in accordance with one or more embodiments. In block 310, tag information may be received. The tag information may include a user identifier corresponding to a user, a tag identifier, and one or more data values. The user identifier may be a value consistently used across various parts of the system to refer to data corresponding to the same user.

The tag identifier may be a value consistently used across various parts of the system to refer to data corresponding to the same tag. The tag identifier may be unique for each tag or may identify a class of tags. The class of tags may correspond to an event type, which may include classifications of user actions performed related to web browsing activity, such as a page view, a click-through, or a conversion. The conversion may be a purchase or other transaction that occurs on the web page.

Regarding the data values, the one or more data values may be any specific values for available properties, segment definitions, or classifications discussed herein. For example, a segment definition may exist for categories such as “Gender”, “Age”, and “Nationality”, and sample data values may include “Male”, “35-40”, and “European.” The segment definitions and range of data values are not limited to these categories and values and may include any categories and range of values. In some embodiments, the data values may include properties, segments, segment definitions, segment identifiers, or classifications.

In some embodiments, front-end server 140 may receive tag information. Tag information may be viewed as a set that relates the user identifier, tag identifier, and one or more data values. Front-end server 140 may receive multiple sets of tag information. When front-end server 140 receives any tag information, front-end server 140 may store the tag information in data cloud 150.

In some embodiments, receiving tag information further comprises distributing a tag to the market information buyer 210, and front-end server 140 may receive the tag information upon execution of the tag. The tag may comprise an executable script configured to determine the user identifier corresponding to the user of a user device, determine the one or more data values based on contents of a web page including the tag that has been received by the user device, and determine the tag identifier. The tag may be placed on website 220. Market information buyer 210 may place the tag.

When website 220 is loaded by a user device, the executable script of the tag may be executed. The executable script may determine the user identifier by reading the value from a cookie stored on the user device, by reading a value loaded from website 220, by reading any other information stored on the user device, or any combination thereof. The executable script may determine the tag identifier by reading the value from a cookie stored on the user device, by reading a value loaded from website 220, by reading any other information stored on the user device, or any combination thereof. The value may include a value set by market information buyer 210 and inserted into the tag that is placed on website 220. The executable script may determine the one or more data values by reading the value from a cookie stored on the user device, by reading a value loaded from website 220, by reading any other information stored on the user device, or any combination thereof. For example, the executable script may analyze website 220 and return the most popular terms as the one or more data values. The executable script may analyze website 220 to determine the most prevalent topics of interest and return those topics as the one or more data values. The executable script may look for specific variables or a specific data set stored on website 220, in a cookie, or elsewhere on the user device

The executable script may be further configured to send the user identifier, the tag identifier, and the one or more data values to front-end server 140. The executable script may send the tag information using any technique, including using HTTP operations like POST, sending the tag information using Javascript or other scripting language, sending the tag information using an module, using email, using a tweet, using a remote procedure call, using any other known technique for sending information from a website to a server, or any combination thereof. The executable script may send the tag information immediately upon being executed. When front-end server 140 receives any tag information, front-end server 140 may store the tag information in data cloud 150.

In some embodiments, the executable script may send the tag information using an asynchronous process used for transmitting contextual data may be Asynchronous JavaScript and XML (AJAX), or a similar process. AJAX refers to a cross-platform technique that may be usable on different operating systems, computer architectures, and web browsers as it is based on open standards such as JavaScript and the DOM. The AJAX system is asynchronous; in that extra data may be requested from a server and loaded in the background without interfering with the display and behavior of an existing page. JavaScript is a scripting language that may be used to make AJAX function calls. Data may be retrieved using the “XMLHttpRequest” object that may be available to scripting languages run in browsers, or alternatively remote scripting in browsers that do not support “XMLHttpRequest.” In embodiments, asynchronous content may be formatted in formats other than XML. AJAX, and related techniques, may exchange small amounts of data with a server as a background functionality so that entire web pages do not have to be reloaded each time there is a need to retrieve data from a server. This may increase a webpage's interactivity, speed, functionality, and usability.

In some embodiments, receiving tag information further comprises receiving the tag information from market information buyer 210, one or more third parties, or any combination thereof. Market information buyer 210, the one or more third parties, or any combination thereof may send the tag information to server-side delivery module 230 of front-end server 140. When front-end server 140 receives any tag information, front-end server 140 may store the tag information in data cloud 150.

A third party may be any individual, group, organization, or any combination thereof. In some embodiments, the third party is not market information buyer 210. In some embodiments, the third party may be a data publisher. In some embodiments, the third party may be a data publisher that is not front-end server 140.

In some embodiments, front-end server 140 may receive tag information from a third party. For example, a data publisher that is not market information buyer 210 may operate its own website. The website may provide tag information to front-end server 140 using any of the techniques described herein.

In block 320, the tag identifier and the one or more data values may be added to a user object. The user object may be identified by the user identifier. The user object may include any information that is identified by the user identifier. For example, a user object may include the tag identifiers and one or more data values from one or more sets of tag information that have the same user identifier. The user object or portions of the user object may be stored in data cloud 150. Front-end server 140 may add the tag identifier and the one or more data values to the user object.

In some embodiments, multiple sets of tag information may be received corresponding to the same user object identified by a user identifier. The multiple sets of tag information may be incorporated into the same user object. A user object may be modified over time, e.g., by with segments, attributes, or any combination thereof, which may enhance the user object with additional tag information. In some embodiments, a user object may require information from multiple tags for enough information to be present about the user to process a model and assign the user object to a segment.

In block 330, the user object may be assigned to a segment based on the user object and a model. The segment may be identified by a segment identifier. Front-end server 140 may receive a model from back-end server 160. The model may comprise one or more algorithms, one or more rules, or any combination thereof, that are applied to an input data set to produce a result. Algorithms may include instructions for processing data to produce results. Rules may include instructions that specify the order and manner in which algorithms are used, how results are used, or any combination thereof. The model may be used to classify the user or user object into one or more segments. For example, a model may have an algorithm that, given a particular user object as an input, filters the user object for specific data values and corresponding tag identifiers, performs various statistical calculations on the data values and tag identifiers to determine which values are significant, and produces a list of segment identifiers with corresponding ranking values. In some embodiments, the model may also process other tag information to produce a list of segment identifiers. For example, the model may use tag information values received from a third party, e.g., a data publisher, in conjunction with the user object to determine the list of segment identifiers and corresponding ranking values. A rule may then select some or all of the segment identifiers based on the ranking values, wherein the selected segment identifiers are the result. The result may be one or more segment identifiers with which a user object may be associated. More than one model may be applied to each user object, and a model may be applied to any number of user objects.

Front-end server 140 may assign the user object based on the model. Front-end server 140 may start processing the user object based on the model as soon as it receives tag information, whether the tag information is received from a tag from website 220 or through server-side delivery module 230.

Back-end server 160 may be configured to produce one or more models using any combination of data of data warehouse 170. Data warehouse 170 may receive and store the user objects and data associated therewith from front-end server 140. Data warehouse 170 may also receive and store the assignment of a user or user object to one or more media segments. Data warehouse 170 may also store any number of segments, segment identifiers, and the relationships between the segments and the user objects.

In block 340, the segment identifier and the user identifier may be distributed to market information buyer 210. The segment identifier and the user identifier may be distributed to market information buyer 210 in various ways.

In some embodiments, distributing the segment identifier and the user identifier to a market information buyer further comprises sending the segment identifier and the user identifier to the user device, and the executable script of the tag is further configured to receive the segment identifier and the user identifier, and send the segment identifier and the user identifier to the market information buyer in response to receiving the segment identifier and the user identifier. Front-end server 140 may send the segment identifier and the user identifier to the executable script of the tag in website 220 loaded on user device 120. The script may be configured to receive the segment identifier and the user identifier, and then send the segment identifier and the user identifier to market information buyer 210. The script may send the data using any technique for sending and receiving data between processes or devices including using a scripting language, a remote procedure call, an email, a tweet, an application programming interfaces, any interface for software components to communicate with each other, using any other known technique for sending information from a one device to another, or any combination thereof. For example, the script may execute a Javascript command that sends the segment identifier and the user identifier to market information buyer device 110 over HTTP.

In some embodiments, distributing the segment identifier and the user identifier to the market information buyer 210 further comprises sending the segment identifier and the user identifier to a market information buyer through a server-side delivery module. Front-end server 140 may send the segment identifier and user object.

In some embodiments, an interface is provided to the market information buyer 210. A request may be received through the user interface from the market information buyer 210 for the segment, wherein the request comprises the segment identifier. Segment information may be sent market information buyer 210. The segment information may comprise a segment definition and a plurality of user identifiers, wherein the plurality of user identifiers may correspond to a plurality of user objects that have been assigned to the segment, and the plurality of user identifiers may include the user object identifier.

The interface may be provided by reporting and management module 240, and reporting and management module 240 may receive a request from market information buyer 210 for segment information. The request may include one or more segment identifiers that identify one or more segments in which the market information buyer 210 is interested. In some embodiments, the interface may present to market information buyer 210 a list of possible segment identifiers from which market information buyer 210 may make a selection of one or more segments. The selection of the one or more segments may be the request for the one or more segments.

In response to receiving the request from market information buyer 210, the interface may send segment information to market information buyer 210. The segment information may include a segment definition, a plurality of user identifiers, or any combination thereof. The segment definition may describe the segment. For example, the segment definition may be a segment identifier, a list of one or many of the attributes used by the model in determining which user objects meet the requirements of the model, any descriptions of the segment, or any combination thereof.

The information received and sent from the interface via reporting and management module 240 may be retrieved by reporting and management module 240 from central database 180. Central database 180 may be configured to store segment information for a plurality of segments, the user identifiers associated with the segments, and the tag identifiers associated with the user identifiers of the stored segments. Central database 180 may receive the segment information for a plurality of segments, the user identifiers associated with the segments, and the tag identifiers associated with the user identifiers of the stored segments from back-end server 160, wherein back-end server 160 receives the information from data warehouse 170.

Back-end server 160 may transmit any or all of the information from data warehouse 170 to central database 180. In some embodiments, back-end server 160 only transmits segment-level data from data warehouse 170 to central database 180. Segment-level data includes information about the identity of the segments and the list of users for each segment that are associated with the segment. Segment-level data may also include one or more data values received from tag information and tag identifiers, but it may not include the information that associates a user identifier with the one or more data values received from tag information or information that associates the user identifier with any of the tag identifiers. This prevents the interface from providing the granular information obtained from receiving tag information that associates particular users with particular tag identifiers and particular data values.

The interface may provide market information buyer 210 with tags, which market information buyer 210 may insert into websites, including website 210. Market information buyer 210 may receive an indication of the tag identifiers included in the tags, and an indication of to what extent the tag identifiers correspond to events. This enables market information buyer 210 to place the tags on appropriate websites. For example, a tag may have a tag identifier that indicates the tag is on a web page, such as website 210, that is displayed after a conversion event has been performed. Market information buyer 210 may place this tag on website 210 so that the tag is executed when a conversion event occurs based on the knowledge that the tag identifier indicates that the tag should be used on web pages in which a conversion events occurs.

The interface may provide a variety of reports regarding one or more segments. The reports may report data or present analysis from any information stored on any of the databases. In some embodiments, the reports may be limited to reporting on or analyzing data receivable from central database 180. The interface may provide the reports to market information buyer 210 or to administrator 250. The reports may include any or all portions of the data stored by central database 180.

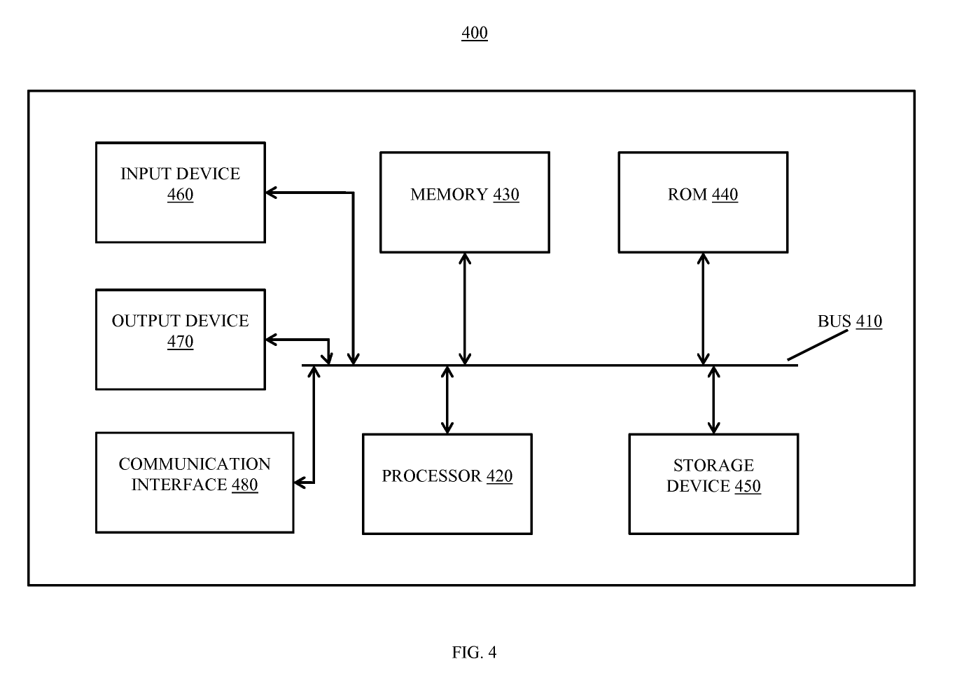

FIG. 4 depicts an exemplary architecture for implementing a computing device 400 in accordance with one or more embodiments, which may be used to implement any of market information buyer device 110, web server 115, user device 120, front-end server 140, back-end server 160, administrator device 190, data cloud 150, data warehouse 170, central database 180, or any other computer system or computing device component thereof. It will be appreciated that other devices that can be used with the computing device 400, such as a client or a server, may be similarly configured. As illustrated in FIG. 4, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method for managing modeled audience extension information, the method comprising:
receiving tag information, the tag information comprising a user identifier corresponding to a user, a tag identifier, and one or more data values;
adding the tag identifier and the one or more data values to a user object, wherein the user object is identified by the user identifier;
assigning, by a server, the user object to a segment based on the user object and a model, wherein the segment is identified by a segment identifier; and
distributing the segment identifier and the user identifier to a market information buyer.

2. The method of claim 1, wherein receiving tag information further comprises:
distributing a tag to the market information buyer, the tag comprising an executable script configured to
determine the user identifier corresponding to the user of a user device,
determine the one or more data values based on contents of a web page that has been received by the user device, wherein the web page includes the tag,
determine the tag identifier, and
send the user identifier, the tag identifier, and the one or more data values to the server; and
receiving the tag information upon execution of the tag.

3. The method of claim 2, wherein distributing the segment identifier and the user identifier to the market information buyer further comprises:
sending the segment identifier and the user identifier to the user device; and
wherein the executable script is further configured to
receive the segment identifier and the user identifier, and
send the segment identifier and the user identifier to the market information buyer in response to receiving the segment identifier and the user identifier.

4. The method of claim 1, wherein receiving tag information further comprises:
receiving the tag information from the market information buyer, a third party, or any combination thereof.

5. The method of claim 1, wherein distributing the segment identifier and the user identifier to the market information buyer further comprises:
sending the segment identifier and the user identifier to a market information buyer through a server-side delivery module.

6. The method of claim 1 further comprising:
providing an interface to the market information buyer;
receiving a request through the user interface from the market information buyer for the segment, the request comprising the segment identifier; and
sending segment information to the market information buyer, the segment information comprising a segment definition and a plurality of user identifiers, wherein the plurality of user identifiers correspond to a plurality of user objects that have been assigned to the segment, and the plurality of user identifiers includes the user object identifier.

7. The method of claim 1, wherein the model further comprises:
one or more algorithms, one or more rules, or any combination thereof, wherein the user object is an input to the model, the one or more algorithms, one or more rules, or any combination thereof are applied to the user object to produce a result, and the result includes the segment identifier.

8. A system for managing modeled audience extension information, the system comprising:
a memory; and
a processor configured to:
receive tag information, the tag information comprising a user identifier corresponding to a user, a tag identifier, and one or more data values;
add the tag identifier and the one or more data values to a user object, wherein the user object is identified by the user identifier;
assign the user object to a segment based on the user object and a model, wherein the segment is identified by a segment identifier; and
distribute the segment identifier and the user identifier to a market information buyer.

9. The system of claim 8, wherein the processor being configured to receive tag information further comprises the processor being configured to:
distribute a tag to the market information buyer, the tag comprising an executable script configured to
determine the user identifier corresponding to the user of a user device,
determine the one or more data values based on contents of a web page that has been received by the user device, wherein the web page includes the tag,
determine the tag identifier, and
send the user identifier, the tag identifier, and the one or more data values to the server; and
receive the tag information upon execution of the tag.

10. The system of claim 9, wherein the processor being configured to distribute the segment identifier and the user identifier to the market information buyer further comprises the processor being configured to:
send the segment identifier and the user identifier to the user device; and
wherein the executable script is further configured to
receive the segment identifier and the user identifier, and
send the segment identifier and the user identifier to the market information buyer in response to receiving the segment identifier and the user identifier.

11. The system of claim 8, wherein the processor being configured to receive tag information further comprises the processor being configured to:
receive the tag information from the market information buyer, a third party, or any combination thereof.

12. The system of claim 8, wherein the processor being configured to distribute the segment identifier and the user identifier to the market information buyer further comprises the processor being configured to:
send the segment identifier and the user identifier to a market information buyer through a server-side delivery module.

13. The system of claim 8, wherein the processor is further configured to:
provide an interface to the market information buyer;
receive a request through the user interface from the market information buyer for the segment, the request comprising the segment identifier; and
send segment information to the market information buyer, the segment information comprising a segment definition and a plurality of user identifiers, wherein the plurality of user identifiers correspond to a plurality of user objects that have been assigned to the segment, and the plurality of user identifiers includes the user object identifier.

14. The system of claim 8, wherein the model further comprises:
one or more algorithms, one or more rules, or any combination thereof, wherein the user object is an input to the model, the one or more algorithms, one or more rules, or any combination thereof are applied to the user object to produce a result, and the result includes the segment identifier.

15. A computer readable storage medium for managing modeled audience extension information, the computer readable storage medium comprising instructions that if executed enable a computing system to:
receive tag information, the tag information comprising a user identifier corresponding to a user, a tag identifier, and one or more data values;
add the tag identifier and the one or more data values to a user object, wherein the user object is identified by the user identifier;
assign the user object to a segment based on the user object and a model, wherein the segment is identified by a segment identifier; and
distribute the segment identifier and the user identifier to a market information buyer.

16. The computer readable storage medium of claim 15, wherein the instructions for receiving tag information further comprises instructions that if executed enable the computing system to:
distribute a tag to the market information buyer, the tag comprising an executable script configured to
determine the user identifier corresponding to the user of a user device,
determine the one or more data values based on contents of a web page that has been received by the user device, wherein the web page includes the tag,
determine the tag identifier, and
send the user identifier, the tag identifier, and the one or more data values to the server; and
receive the tag information upon execution of the tag.

17. The computer readable storage medium of claim 16, wherein the instructions for distributing the segment identifier and the user identifier to the market information buyer further comprises instructions that if executed enable the computing system to:
send the segment identifier and the user identifier to the user device; and
wherein the executable script is further configured to
receive the segment identifier and the user identifier, and
send the segment identifier and the user identifier to the market information buyer in response to receiving the segment identifier and the user identifier.

18. The computer readable storage medium of claim 15, wherein the instructions for receiving tag information further comprises instructions that if executed enable the computing system to:
receive the tag information from the market information buyer, a third party, or any combination thereof.

19. The computer readable storage medium of claim 15, wherein the instructions for distributing the segment identifier and the user identifier to the market information buyer further comprises instructions that if executed enable the computing system to:
send the segment identifier and the user identifier to a market information buyer through a server-side delivery module.

20. The computer readable storage medium of claim 15 further comprising instructions that if executed enable the computing system to:
provide an interface to the market information buyer;
receive a request through the user interface from the market information buyer for the segment, the request comprising the segment identifier; and
send segment information to the market information buyer, the segment information comprising a segment definition and a plurality of user identifiers, wherein the plurality of user identifiers correspond to a plurality of user objects that have been assigned to the segment, and the plurality of user identifiers includes the user object identifier.
